(19) United States
(12) Patent Application Publication
(10) Pub. No.: US 2021/0309000 A1
(43) Pub. Date: Oct. 7, 2021

(54) VAPORIZABLE ANTICORROSIVE COATING PAPER AND MANUFACTURING METHOD THEREFOR

(71) Applicant: SAMBU TECH CO., LTD., Gyeongju-si, Gyeongsangbuk-do (KR)

(72) Inventor: Ho Jin RYU, Gimhae-si, Gyeongsangnam-do (KR)

(73) Assignee: SAMBU TECH CO., LTD., Gyeongju-si, Gyeongsangbuk-do (KR)

(21) Appl. No.: 17/266,887

(22) PCT Filed: Aug. 9, 2019
(86) PCT No.: PCT/KR2019/010035

§ 371 Date: Feb. 8, 2021

(30) Foreign Application Priority Data
Aug. 14, 2018 (KR) 10-2018-0094669
Dec. 24, 2018 (KR) 10-2018-0168754
Dec. 24, 2018 (KR) 10-2018-0168757
Jul. 16, 2019 (KR) 10-2019-0085563

(51) Int. Cl. B32B 29/06; B32B 27/32; B32B 37/12; B32B 3/26; B32B 27/10; B32B 7/02; B32B 7/14; B32B 29/02; B32B 27/18; D21H 21/38; D21H 17/14; D21H 17/00; D21H 17/63; D21H 17/07; D21H 19/22

(52) U.S. Cl. CPC B32B 29/06; B32B 2255/26; B32B 37/1292; B32B 3/266; B32B 27/10; B32B 7/02; B32B 7/14; B32B 29/02; B32B 27/18; D21H 21/38; D21H 17/14; D21H 17/74; D21H 17/63; D21H 17/07; D21H 19/22; B32B 2307/752; B32B 2553/00; B32B 2255/12; B32B 27/32

(57) ABSTRACT

Disclosed is an anticorrosive coating paper and a method for manufacturing the paper. The paper includes a base material containing an anticorrosive agent, a film layer adhered to one surface of the base material and configured to provide a vaporization passage for the anticorrosive agent, and a reinforcing material layer adhered to the other surface of the base material. The method incudes punching a film and providing a film layer having a flow passage that provides a vaporization passage for an anticorrosive agent, adhering the film layer having the flow passage to one surface of a base material containing the anticorrosive agent, and adhering a reinforcing material layer to the other surface of the base material.

### CROSS-REFERENCE TO PRIOR APPLICATIONS

This application is a National Stage Patent Application of PCT International Patent Application No. PCT/KR2019/010035 (filed on Aug. 9, 2019) under 35 U.S.C. § 371, which claims priority to Korean Patent Application Nos. 10-2018-0094669 (filed on Aug. 14, 2018), 10-2018-0168754 (filed on Dec. 24, 2018), 10-2018-0168757 (filed on Dec. 24, 2018), and 10-2019-0085563 (filed on Jul. 16, 2019), which are all hereby incorporated by reference in their entirety.

### BACKGROUND

The present invention relates to a vaporizable anticorrosive paper (vapor corrosion inhibitor paper) and a manufacturing method therefor, and more particularly, to a vaporizable anticorrosive paper for preventing corrosion when packaging steel products such as steel coils, metal machines, metal components and the like, and a method for manufacturing the same.

A vaporizable anticorrosive packaging material for preventing corrosion when packaging steel products, metal machines, metal components, or the like has been disclosed.

Anticorrosive packaging materials used for packaging steel coil products such as cold rolled coils have been used in an anticorrosive paper form or in an anticorrosive film form by impregnating conventional vaporizable corrosion inhibiting agents (vapor corrosion inhibitor) into paper materials such as kraft paper or by mixing the agents with synthetic resin materials such as polyethylene and extruding the mixture, and attaching a reinforcing material such as a gunnysack to the paper materials or synthetic resin materials.

In case of anticorrosive packaging materials having anticorrosive paper forms, satisfactory anticorrosive agent impregnation property and vaporizable corrosion inhibiting performance can be achieved due to porous structures of the paper materials themselves composed of cellulose fibers. However, in the manufacturing process for paper materials such as kraft paper, materials such as chlorine components or sulfate components that may affect corrosion of metal materials are used, and such anticorrosive paper strongly absorbs inunction components applied to products such as steel coils to improve corrosion prevention and processibility and may rather degrade the quality of products, and there are also severe cases in which corrosion is caused due to moisture excessively contained in the paper.

On the contrary, in case of anticorrosive packaging materials having anticorrosive film forms, self moisture permeability prevention performance and oil absorption prevention performance are satisfactory, but high-temperature extrusion processes are applied in an anticorrosive film manufacturing process and thus the anticorrosive performance is bound to be degraded.

As such, in the conventional field of anticorrosive packaging materials for steel products and the like, either an anticorrosive paper form or an anticorrosive film form should be selected, so that there is a problem in that some characteristics are satisfactory, but characteristics conflicting therewith are bound to be sacrificed.

Meanwhile, considering the problem in the application of anticorrosive films, laminating of materials such as a gunnysack having high permeability may be considered for anticorrosive packaging materials having anticorrosive paper form, but in order to stack paper materials and gunnysacks, adhesive layers such as polyethylene coating layers are required to be formed between the paper materials and the gunnysacks, and at this point, there is a problem in that anticorrosive components vaporized from the anticorrosive papers are blocked due to permeability problem and the anticorrosive performance is degraded.

That is, in a coating method for forming such coating layers, extrusion and thermal coating methods are generally applied to form a composite layer and enhance waterproof or air permeation prevention function, but existing coating methods cannot ensure permeability and having difficulty in applications for achieving materials that require permeability and materials that do not require permeability prevention function according to the field of the material applied together with anticorrosive paper.

For example, when a coating layer is formed through a general method in order to reinforce a mat for preventing weeds or a material for a nonwoven fabric cover, durability may be improved while maintaining inherent light shield performance of the mat and nonwoven fabric, but there is a side effect in that permeability is remarkably degraded and the fertility of soil is decreased.

In addition, in order to reinforce a paper material containing an anticorrosive agent in an anticorrosive packaging material, reinforcing material layers such as gunnysacks are laminated with polyethylene coating layers serving as adhesive layers, but there is a problem in that anticorrosive components vaporized from anticorrosive paper are blocked by the adhesive layers and anticorrosive performance is degraded.

Japanese Utility Model Publication No. 5-22369 discloses, regarding a packing sheet for metal products, a packaging sheet in which an air-tight waterproof film is laminated on the inner layer of an anticorrosive paper to improve waterproof function, but there is a problem in that anticorrosive components vaporized from the anticorrosive paper are blocked by the waterproof film on the inner layer, and the anticorrosive performance is also bound to be sacrificed.

### SUMMARY

Accordingly, the present invention has been devised to solve the above-described problem, and is to provide, in a vaporizable anticorrosive packaging paper for preventing corrosion when steel products, metal machines, metal products or the like are packaged, anticorrosive paper that maintains merits of conventional anticorrosive paper forms and anticorrosive film forms, but excludes demerits thereof, and is thus also excellent in characteristics, such as moisture permeation prevention performance and oil absorption prevention performance, that conflicts with anticorrosive performance while achieving excellent anticorrosive performance.

The present invention is also to provide: an optimal method for manufacturing an anticorrosive paper having a new lamination structure as an anticorrosive paper having excellent anticorrosive performance and excellent characteristics conflicting with the anticorrosive performance; and anticorrosive coating paper to which a new method for manufacturing the anticorrosive paper having a specific lamination structure is applied.

The present invention is also to provide, in a coating method for forming a coating layer for adhering materials to each other when a composite layer is formed in the materials having various sheet shapes such as papers, nonwoven fabrics, fibers, cloths or plastic films, a coating method for obtaining a material that requires air permeation or does not require air permeation prevention function according to the fields of the materials, and for forming a coating layer with a mesh-like structure.

In a first aspect to solve the problem, the present invention provides anticorrosive coating paper including: a base material containing an anticorrosive agent; a film layer adhered to one surface of the base material and having a flow passage that provides a vaporization passage for the anticorrosive agent; and a reinforcing layer adhered to the other surface of the base material.

In addition, there is provided anticorrosive coating paper characterized in that the base material is a natural material or a synthetic material.

In addition, there is provided anticorrosive coating paper characterized in that the base material includes paper.

In addition, there is provided anticorrosive coating paper characterized in that the paper is one or more selected from the group consisting of kraft paper, wiping paper, paperboard, tissue paper, and synthetic paper.

In addition, there is provided anticorrosive coating paper characterized in that the anticorrosive agent includes one or more selected from the group consisting of a fatty acid or a salt thereof; a cyclic compound including nitrogen or sulfur; an alkali metallic salt; and an aromatic acid or a salt thereof.

In addition, there is provided anticorrosive coating paper characterized in that the film layer includes a polyolefin-based resin.

In addition, there is provided anticorrosive coating paper characterized in that the flow passage is formed by punching.

In addition, there is provided anticorrosive coating paper characterized in that the flow passage has a pore shape having a diameter of 1-2,000 μm and an inter-pore interval of 0.1-40 mm.

In addition, there is provided anticorrosive coating paper characterized in that the flow passage is formed by a pore forming additive contained in a film base material.

In addition, there is provided anticorrosive coating paper characterized in that the additive includes at least one selected from the group consisting of calcium carbonate, talc, silica, or a foaming agent.

In addition, there is provided anticorrosive coating paper characterized in that the film layer contains an anticorrosive component.

In addition, there is provided anticorrosive coating paper characterized in that the reinforcing material layer is a film, a gunnysack, a fabric, or a composite thereof.

In a second aspect to solve the problem, the present invention provides a method for manufacturing anticorrosive coating paper, the method including: (a) punching a film to form a film layer having a flow passage that provides a vaporization passage for an anticorrosive agent; (b) adhering the film layer having the flow passage to one surface of a base material containing the anticorrosive agent; (c) adhering a reinforcing material layer to the other surface of the base material.

In addition, there is provided a method for manufacturing anticorrosive coating paper, the method including: (a) forming a film layer on one surface of a base material containing an anticorrosive agent; (b) punching the base material having the film layer formed thereon to form a flow passage that provides a vaporization passage for the anticorrosive agent; and (c) adhering a reinforcing material layer to the other surface of the base material.

In addition, there is provided a method for manufacturing anticorrosive coating paper, the method comprising: (a) adding and processing a pore forming additive to a film base material to form a film layer having a flow passage that provides a vaporization passage for an anticorrosive agent; (b) adhering the film layer having the flow passage formed thereon to one surface of a base material containing an anticorrosive agent; and (c) adhering a reinforcing material layer to the other surface of the base material.

In a third embodiment to solve the problem, the present invention provides anticorrosive coating paper in which a base material containing an anticorrosive agent and a first reinforcing material layer are laminated and formed with an adhesive layer therebetween, wherein the adhesive layer has a mesh-like structure or a stripe structure.

In addition, there is provided anticorrosive coating paper characterized in that the first reinforcing material layer is a gunnysack, a nonwoven fabric, a cloth or a composite thereof.

In addition, there is provided anticorrosive coating paper characterized in that the adhesive layer includes a polyolefin-based resin.

In addition, there is provided anticorrosive coating paper characterized in that the mesh-like structure is a structure having an indeterminate shape and an ultra large pore structure in which an average size (with respect to smallest inner diameter) of pores may be 1-300 mm, and a porosity per unit area may be 10-90%.

In addition, there is provided anticorrosive coating paper characterized in that the mesh-like structure is formed by adding an additive that forms a huge pore at the extrusion temperature when an adhesive layer is formed by extruding the resin through a T-die method.

In addition, there is provided anticorrosive coating paper characterized in that the mesh-like structure is formed in a condition of the extrusion temperature of 250-450° C. when an adhesive layer is formed by extruding the resin through a T-die method.

In addition, there is provided anticorrosive coating paper characterized in that in the stripe structure, an interval ratio of an adhesive layer forming section to a non-adhesive forming section is 1:0.1 to 1:10.

In addition, there is provided anticorrosive coating paper characterized in that a vaporization prevention layer for preventing vaporization of the anticorrosive agent is further laminated on the base material.

In addition, there is provided anticorrosive coating paper characterized in that the vaporization prevention layer includes: a film layer including a polyolefin-based resin; or a second reinforcing material layer which is a gunnysack, a nonwoven fabric, a cloth, or a composite thereof.

In a fourth aspect to solve the problem, the present invention provides a coating method characterized in that, in a resin coating layer is formed on one surface a base material, and the coating layer is formed by 1) extruding a resin on one surface of the base material through a T-die method and thermally adhering the resultants or 2) manufacturing a resin in a sheet shape by extruding the resin through a T-die method and laminating the sheet, wherein an additive that forms a huge pore in the resin at the temperature of the extrusion is added to form the coating layer with a mesh-like structure.

In addition, there is provided a coating method characterized in that the resin includes a polyolefin-based resin.

In addition, there is provided a coating method characterized in that the additive is one or more selected from the group consisting of one or more inorganic materials selected from the group consisting of calcium carbonate, talc, titanium dioxide, silica, barium sulfate, and mica, and a hydrophilic material containing a foaming agent, a vaporizable anticorrosive agent and moisture.

In addition, there is provided a coating method characterized in that a resin coating layer is formed on one surface a base material, and the coating layer is formed by 1) extruding a resin on one surface of the base material through a T-die method and thermally adhering the resultants or 2) manufacturing a resin in a sheet shape by extruding the resin through the T-die method and laminating the base material and the sheet, wherein the coating layer with a mesh-like structure is formed in a condition that a temperature of the extrusion is 250-450° C.

According to the present invention, there may be provided an anticorrosive paper that maintains merits of conventional anticorrosive paper forms, is also excellent in moisture permeation prevention performance and oil absorption prevention performance, which conflicts with anticorrosive performance and are pointed out as demerits, and is capable of adjusting anticorrosiveness according to the degree of forming a flow passage of the film layer.

In addition, as a method for manufacturing an anticorrosive paper having a new lamination structure with excellent anticorrosive performance and excellent characteristics conflicting with the anticorrosive performance, an optimal method capable of achieving a film layer having flow passage formed thereon to provide a vaporization passage for an anticorrosive agent may be provided.

In addition, there may be provided an anticorrosive paper in which a base material and a first reinforcing material layer are laminated and formed with an adhesive layer therebetween, and which maintains excellent anticorrosive performance that is merits of conventional anticorrosive paper forms and is also excellent in moisture permeation prevention performance and oil absorption prevention performance, which conflicts with anticorrosive performance and are pointed out as demerits, by forming the adhesive layer in a mesh-like structure or in a stripe structure.

In addition, there may be provided an anticorrosive paper in which a new method for manufacturing anticorrosive coating paper having a specific lamination structure that has excellent anticorrosive performance and excellent characteristics conflicting with the anticorrosive performance is applied, and in which when an adhesive layer is formed by extruding an adhesive layer resin through a T-die method, an additive for forming a huge pore at an extrusion temperature is added, the adhesive layer is formed in a condition of the extrusion temperature of 250-450° C. or is formed in a stripe pattern, so that anticorrosive coating paper may be provided which has a mesh-like structure with a ultra large pore structure or a stripe structure by a simple method.

In addition, there may be provided a coating method for forming a resin coating layer on one surface of the base material, the method being performed by extruding a resin in a T-die method to form a coating layer, adding an additive for forming a huge pore at an extrusion temperature, or being performed in a condition of the extrusion temperature of 250-450° C., whereby a coating layer which has a mesh-like structure having an ultra large pore structure may be achieved by a simple method using a large-width extrusion process of the T-die method.

In addition, a coating method according to the present invention may satisfy requirements for materials that are required to be manufactured as a composite sheet which includes various functional layers according to the types of materials and does not hinder air permeability due to a coating layer.

### BRIEF DESCRIPTION OF THE DRAWINGS

FIG. 1 is a schematic view illustrating a cross-section of anticorrosive coating paper according to a first embodiment of the present invention.

FIGS. 2 to 4 are flowcharts illustrating a manufacturing process for anticorrosive coating paper according to a second embodiment of the present invention.

FIG. 5 is a photograph showing a film layer surface of an anticorrosive paper manufactured according to example 1.

FIGS. 6 to 9 are photographs respectively showing evaluation results for vaporizable anticorrosiveness, contact anticorrosiveness, and oil absorption.

FIG. 10 is a schematic view illustrating a cross-section of anticorrosive coating paper according to a third embodiment of the present invention.

FIG. 11 is a schematic view illustrating a cross-section of anticorrosive coating paper according to another implementation example of the third embodiment of the present invention.

FIG. 12 is a photograph illustrating an adhesive coating layer extruded and formed from a T-die in example 2-1 of the present invention.

FIG. 13 is a photograph showing a state in which an adhesive coating layer is coated on to a substrate in example 2-1 of the present invention.

### DETAILED DESCRIPTION

Hereinafter, the present invention will be described in detail through preferable embodiments. First of all, it will be understood that words or terms used in the specification and claims shall not be interpreted as the meaning defined in commonly used dictionaries. It will be further understood that the words or terms should be interpreted as having a meaning that is consistent with their meaning in the context of the relevant art and the technical idea of the invention, based on the principle that an inventor may properly define the meaning of the words or terms to best explain the invention. Therefore, the features of the embodiments and drawings described herein are merely the most preferable exemplary embodiment for the purpose of illustrations only, not intended to represent all the technical concepts of the disclosure, so it should be understood that various modifications and equivalents could be made thereto at the time of present application. Furthermore, in the entire specification, when it is described that one part “includes” some components, it does not mean that other components are excluded but means that other elements may be further included if there is no specific contrary description.

Regarding a vaporizable anticorrosive packaging material for preventing corrosion during packing of steel products, metal machines, metal components or the like, the present inventors have repeated research to develop an anticorrosive paper which has merits of each of conventional anticorrosive paper forms and anticorrosive film forms and excludes demerits, and has superior characteristics, such as moisture permeation prevention performance and oil absorption prevention performance, which conflict with anticorrosiveness while achieving excellent anticorrosiveness. As a result, the present inventors found that the developed anticorrosive paper has superior characteristics, such as moisture permeation prevention performance and oil absorption prevention performance, which conflict with anticorrosiveness while having anticorrosive performance which is the merit of the conventional anticorrosive paper forms, and the anticorrosiveness thereof can be adjusted according to the degree of a flow passage creation in a film layer by 1) adhering the film layer, in which the flow passage for providing a vaporization passage of an anticorrosive agent is formed, to one surface of a substrate containing the anticorrosive agent, and 2) forming adhesive layers in a mesh-like structure or strip structure in the anticorrosive paper formed by laminating the substrate containing the anticorrosive agent and a first reinforcement material layer between the adhesive layers.

In addition, the present inventors squarely face the reality in which in a coating method for forming a coating layer for attaching composite layers when forming the composite layers on various sheet-like materials, such as papers, nonwoven fabrics, fibers, cloths, or plastic films, it is necessary to achieve a material requiring air permeability and a material not requiring permeation prevention function, but the necessity of achieving such a material has not been not recognized up to now, and in particular, a method that can easily achieve such a material has not been proposed. Accordingly, the present inventors have repeated research and consequently arrive at the present invention by founding that a mesh-structure coating layer having an ultra big porous structure can be simply achieved through a coating method which is for forming a resin coating layer on one surface of a base material, and in which a resin is extruded through a T-die method to form a coating layer, and an additive for forming big pores at the extrusion temperature is added or the method is performed in conditions of extrusion temperature of 250-450° C. using a T-die type extrusion process.

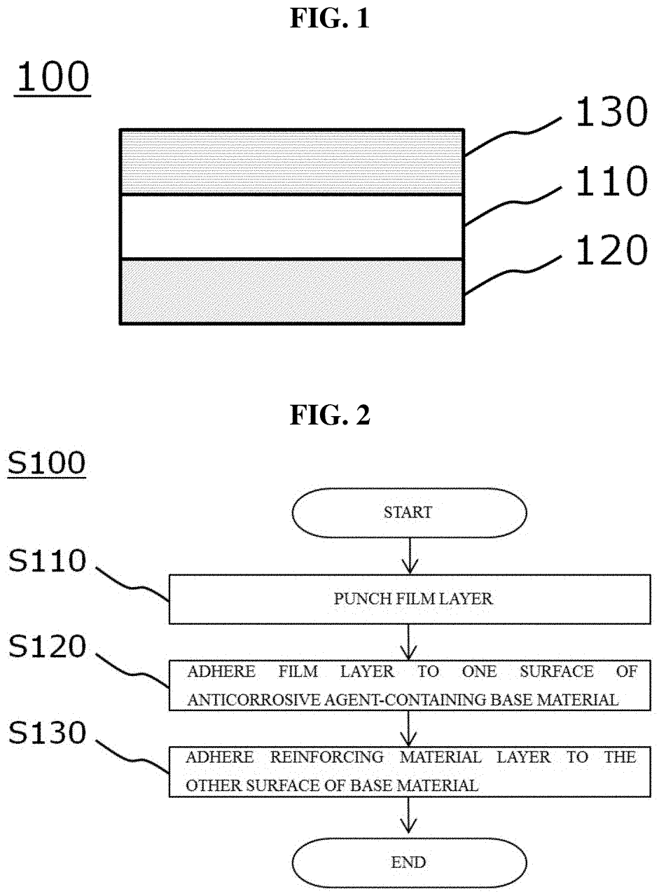

FIG. 1 is a schematic view illustrating a cross-section of anticorrosive coating paper according to a first embodiment of the present invention.

Referring to FIG. 1, the present invention discloses an anticorrosive paper 100 including; a base material 110 containing an anticorrosive agent; a film layer 120 in which a flow passage that is adhered to one surface of the base material and provides a vaporization passage for the anticorrosive agent; and a reinforcing material layer 130 adhered to the other surface of the base material.

The “flow passage” in the present invention means a movement passage for gas-state material which is formed so that anticorrosive components vaporized from the anticorrosive agent contained in the base material may pass through the film layer adhered to the base material and be diffused to the outside of the coating paper, that is, a vaporization passage, and as described later, the shapes, the patterns and the like of the flow passage may be diversified, and the present invention does not particularly limit the flow passage.

In the present invention, the base material 110 has anticorrosive agents through a method such as impregnation and coating and which is for preventing rusts and corrosion of a metal by forming a thin passive state film on the surface of the metal through the vaporization of the anticorrosive agents during packaging a final anticorrosive paper on a product such as a steel coil and by blocking contact with moisture and oxygen.

The type of the base material 110 is not particularly limited as long as a material, such as a natural material such as paper, a synthetic material such as nonwoven fabric and cloth, which is capable of achieving vaporizable anticorrosive performance, but a material including paper with excellent vaporizing performance is desirable, such as kraft paper, wiping paper, paperboard, tissue paper, or synthetic paper may preferably be used, and more preferably, kraft paper may be used.

As described above, in the present invention, the anticorrosive agent is a composition which is contained in the base material 110 and forms a thin passive film on a metal surface of a product by being vaporized when packaging a product, and is not particularly limited as long as a composition including a vaporizable anticorrosive component.

However, the anticorrosive agent is required to have balanced volatility and sustained release and a composition suitable for impregnation and coating to a base material 110, in particular, to a paper base material. Thus, the present invention may include, as the anticorrosive agent, one or more selected from the group consisting of, for example, a fatty acid or a salt thereof, a cyclic compound including including oxygen, nitrogen or sulfur, an alkali metallic salt, and an aromatic acid or a salt thereof.

The fatty acid may be selected from among fatty acids with carbon numbers of 3 to 20 and used, and more preferably, butyric acid, caproic acid, caprylic acid, capric acid, lauric acid, stearic acid, or the like may be selected and used.

In addition, for example, 1,2,3-benzotriazole, tolytriazole, 5-chlorobenzotriazole, mercaptobenzotriazole, 3-aminotriazole, imidazole or benzoimidazole may be selected and used as the cyclic compound.

In addition, for example, sodium carbonate, sodium benzoate, sodium nitrite, potassium nitrate or potassium nitrite may be selected and used as the alkali metallic salt.

In addition, for example, salicylic acid or benzoic acid may be selected and used as the aromatic acid.

A suitable content ratio for the vaporizable anticorrosive agent may be composed of 5-30 wt % of the fatty acid or a salt thereof, 1-30 wt % of the cyclic compound, 1-20 wt % of the alkali metallic salt, 5-40 wt % of the aromatic acid or a salt thereof, and remaining contents of water or alcohol.

In the present invention, the film layer 120 is a layer which is adhered to one surface of the base material 110 and provides a vaporization passage for the anticorrosive agent, has excellent characteristics such as moisture permeation prevention performance and oil absorption prevention performance that conflict with the anticorrosive performance and is pointed out as a demerit while maintaining excellent anticorrosiveness that is a merit of the conventional anticorrosive paper, and has anticorrosiveness that can be adjusted according to the degree of forming a flow passage of the film layer.

That is, direct contact between the base material and the metal surface of a product is prevented by selecting a material with low moisture absorption and oil absorption for the film layer 120, thereby overcoming a demerit of the base material 110 composed of a conventional paper material. In addition, vaporizable anticorrosive performance can be sufficiently exhibited by causing the vaporizable anticorrosive component to be smoothly vaporized through a plurality of flow passages formed in the base material 110, whereby the same level of anticorrosiveness as the existing anticorrosive paper may be ensured. Furthermore, the anticorrosive performance may appropriately be adjusted according to a required degree by variously applying the flow passage forming pattern and the shape of the film layer.

The material constituting the film layer 120 is not particularly limited as long as the material aside from a paper material has a low moisture absorption and oil absorption, and commercial polyolefin resins based on polyethylene, polypropylene, or the like may preferably used.

The flow passage of the film layer 120 may be formed through various methods, and is not particularly limited as long as the flow passage is formed by any method so as to sufficiently serve as a discharge passage for the anticorrosive component which is contained in the base material and is vaporized.

For example, the film layer 120 may be a film layer in which the flow passages are formed by punching.

The punching method is not particularly limited, for example, a film punched by using pin holes or laser may be used. At this point, in terms of anticorrosive balancing such as overall volatility, sustained release, or coherence, the pores formed by punching are preferably formed so that the diameters thereof are 1-2,000 μm, and the intervals between the pores are 0.1-40 mm, and more preferably, the diameters of the pores may be 50-800 μm and the intervals between pores are 0.8-10 mm.

In another example, the film layer 120 may be a film layer in which flow passage are formed by containing a pore forming additive in the film base material.

A method for forming flow passages in the film layer 120 using the pore forming additive may be implemented such that the pore forming additive is added to an olefin resin or the like serving as a film base material, and the film layer 120 is manufactured by well-known extrusion such as a T-die method or a circular-die method, and by elongation if necessary.

The pore forming additive is not particularly limited as long as being added during film forming and capable of exhibiting flow passage forming performance, for example, calcium carbonate, talc, silica, or a foaming agent may be used, and preferably, calcium carbonate may be used.

Meanwhile, the flow passages of the film layer 120 may have various punched shapes, such as ellipses or polygons, aside from a general circle with respect to lateral cross-section (or when viewed from the upper surface of the coating paper), and may, of course, be formed also in various patterns (straight shape, X shape, streamlined shape, various figures, letters, or the like) aside from general point shape.

The film layer 120 may form a space together with the metal surface of the product or make direct contact with the metal surface, and the film layer 120 may be configured to have metal contact anticorrosive performance while serving as passage for the vaporizable anticorrosive component of an anticorrosive paper according to the present invention. A contact anticorrosive component has no self volatility, but forms a surface layer during contact and functions to prevent corrosion of a metal.

Accordingly, in the present invention, a general film may also serve as a material for the film layer 120 in which flow passages are formed, but in order to maximize anticorrosive effect, according an embodiment of the present invention, the film layer 120 may further include an anticorrosive component such as contact anticorrosive component.

The anticorrosive component may be further added as an anticorrosive additive together with the film base material and the pore forming additive and be contained in the film layer.

As such an anticorrosive additive, for example, one or more selected from the group consisting of sodium nitrite, ammonium phosphate, sodium carbonate, sodium benzoate, ammonium benzoate, 1,3,3-benzotriazole, tolytriazole, 5-chlorobenzotriazole, and 3-aminotriazole may be selected and used.

Meanwhile, in the present invention, the adhering of the film layer 120 may be performed by using a general coating method when a thermoplastic resin material, such as polyethylene or polypropylene, is applied, performed by using a general lamination method by preparing in a separate film form, and the method is not particularly limited.

In the present invention, the reinforcing material layer 130 is a layer which is adhered to the other surface of the base material 110 and is formed to supplement lacing physical property, such as waterproof property, airtightness and strength, of a material for the base material, and various types of materials having various physical properties may be applied according to required purposes.

Materials generally used in the technical field to which the present invention belongs may be used as such a material for the reinforcing material layer 130, for example, films for imparting waterproof function such as OPP films, CPP films or polyethylene films, gunnysack, nonwoven fabrics, cloths, or a composite thereof for improving strength may be adopted, and the material is not particularly limited in the present invention.

When a gunnysack fabric is used as a material for the reinforcing material layer 130, the thread count (number of threads used per inch) is not particularly limited, for example, a gunnysack fabric with 10×10 thread count or 8×8 thread count may be used.

In adhering the reinforcing material layer 130, a thermoplastic resin such as general polyethylene, polypropylene, or polyethylene terephthalate may be used, but an adhesive such as hot melt may of course be used.

An anticorrosive packaging material using the base material 110 containing an anticorrosive agent and the reinforcing material layer 130 should satisfy several requirements for packing steel products such as steel coils. First is anticorrosiveness such that oxidization of metal due to transportation and storage after packaging a steel product may be prevented to protect the metal product. Second is strength, and in order to package a heavy steel coil, a certain tensile strength, tearing strength and a fracture strength are required. Third is a packaging suitability because when packaging a steel coil, the steel coil is packaged by an automatic or semi-automatic packaging machine or manually packaged in many cases, and in this case, the packaging work is easy only when the packaging material has bendability and flexibility, and there is no curl phenomenon as an additional important requirement When a curl phenomenon occurs, the efficiency of the packaging work is degraded and tiredness increases.

Anticorrosive coating paper 100 according to the present invention may exclude all demerits of anticorrosive packaging materials having anticorrosive paper forms and anticorrosive film forms while sufficiently satisfying the above requirements.

Hereinafter, a method for manufacturing anticorrosive coating paper according to a second embodiment of the present invention will be described in detail.

The manufacturing of anticorrosive coating paper according to the present invention may be performed through various methods according to a film layer forming method.

FIGS. 2 to 4 are flowcharts illustrating a manufacturing process for anticorrosive coating paper according to a second embodiment of the present invention.

Referring to FIG. 2, first is a first manufacturing example S100. The manufacturing of anticorrosive coating paper according to the present invention may be performed by including: (a) punching a film and forming a film layer in which flow passages for providing vaporization passages for an anticorrosive agent (S110); (b) adhering the film layer having the flow passages formed thereon to one surface of a base material containing the anticorrosive agent (S120); and (c) adhering a reinforcing material layer to the other surface of the base material (S130).

As described above, the film layer having the flow passage formed thereon may be formed by punching the prepared film using pin holes, laser, or the like so that predetermined pore diameters and inter-pore intervals are provided.

The base material containing the anticorrosive agent may be manufactured by impregnating or coating a vaporizable anticorrosive agent to the base material through a method such as gravure, spray, or knife, and drying the gent with hot air or a heating roll. At this point, the applied amount of the vaporizable anticorrosive agent may be different according to the required degree of vaporization, but may be appropriately determined, for example, within a range of 5-100 g/m².

Here, an anticorrosive agent coating process using a gravure method is exemplarily described. First, the anticorrosive agent is applied to a gravure coating roll so that a desired amount the anticorrosive agent is applied to the base material. While the base material passes between the gravure coating roll and a silicone roll, the anticorrosive agent is coated from one side surface and infiltrates into the other side surface. At this point, the distance between the gravure coating roll and the silicone roll is adjusted so that the anticorrosive agent easily infiltrates into the base material and the desired applied amount of anticorrosive agent is obtained. During the coating, in order to adjust a mechanical tension, work is performed by minimizing occurrence of tension before and after coating by controlling the mechanical operation speeds of an unwinder part and the rewinder part of an anticorrosive coating machine at a ratio of the speeds of the unrewinder part to the rewinder part at about 1.01-1.1:1 using a PIV continuously variable transmission. The unwinder part serves as a shaft for unwinding the roll that winds the base material, and the rewinder part serves as a shaft for rewinding the coated and dried base material. Subsequently, the base material which is coated with the vaporizable anticorrosive agent is dried in a drying chamber and the vaporizable anticorrosive agent is attached to the base material. The coated base material id dried while passing through a drying chamber, and the temperature of the drying chamber may be 70-120° C. Subsequently, if necessary, surface heat treatment is performed on the dried and coated base material using a heating roll, whereby redrying may be performed. The base material having passed through the drying chamber is brought into direct contact with the front and rear surfaces of the heating roll which is set to about a temperature of 70-150° C., the anticorrosive agent infiltrating between fibrous pores of the base material is secondly dried, and the base material is pressed by bringing the surface of the base material into thermal contact with the heating roll, whereby the anticorrosive agent may be completely dried and a smooth coating base material may be manufactured.

Subsequently, the film layer, in which flow passages are formed, is coated or laminated, and is thereby adhered to one surface of the base material containing the anticorrosive agent, and the reinforcing material layer is adhered to the other surface of the base material by using a thermoplastic resin such as polyethylene, polypropylene, or polyethylene terephthalate, whereby a final anticorrosive coating paper may be manufactured.

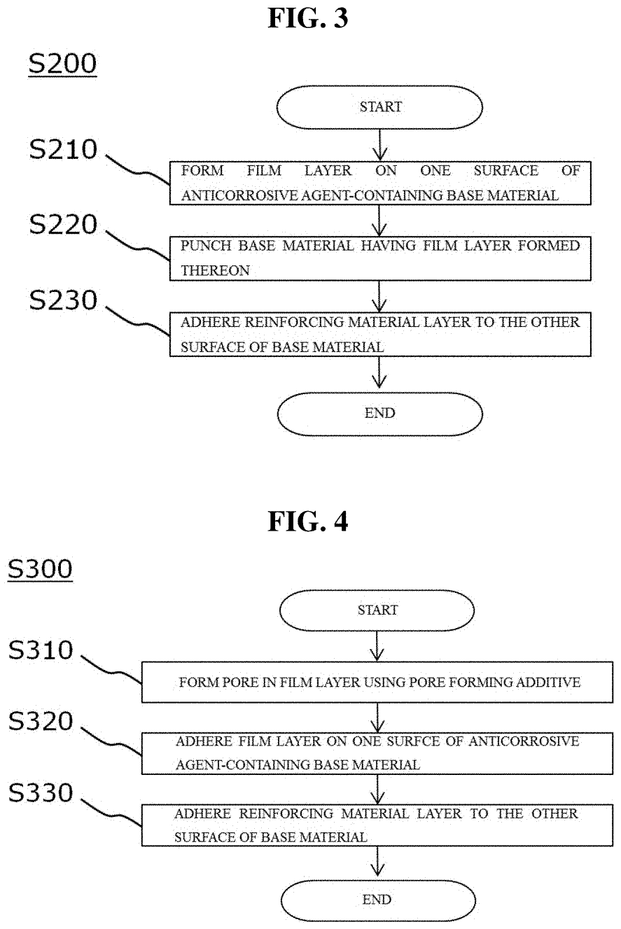

Next, referring to FIG. 3, which illustrates a second manufacturing example S200, manufacturing of anticorrosive coating paper according to the present invention may be performed by including: (a) forming a film layer on one surface of a base material containing an anticorrosive agent (S210); (b) punching the base material having the film layer formed thereon and forming flow passages that provides a vaporization passage (S220); and (c) adhering a reinforcing material layer to the other surface of the base material (S230).

Unlike in the first manufacturing example S200, in the second manufacturing example S200, the film layer is first formed on the base material containing the anticorrosive agent, and then the base material having the film layer formed thereon is punched, that is, not only the film layer but also the base material is simultaneously punched, whereby the base material and the film layer are adhered and formed, and other specific manufacturing processes are the same as those in the first manufacturing example S100.

However, in the second manufacturing example S200, the film layer may also be prepared in a form of a separate film and punched after being laminated on the base material as in the first manufacturing example S100, but when the film layer is formed by a thermoplastic resin, punching may be performed after the thermoplastic resin is coated on the base material.

Next, referring to FIG. 4, which illustrates a third manufacturing example S300, the manufacturing of anticorrosive coating paper according to the present invention may be performed by including: (a) adding a pore forming agent to a film base material and processing the film, thereby forming a film layer in which flow passages for providing a vaporization passage for an anticorrosive agent (S310); (b) adhering the film layer having the flow passages formed thereon to one surface of a base material containing the anticorrosive agent (S320); and (c) adhering a reinforcing material layer to the other surface of the base material (S330).

The third manufacturing example S300 is characterized by using the film in which the flow passages are formed by a specific additive in the film layer manufacturing process unlike the first manufacturing example S100 and the second manufacturing example S200 in which flow passages are formed by punching the film layer.

In the third manufacturing example S300, the film layer having the flow passages formed thereon may be formed by manufacturing the film layer by mixing the pore forming additive with the film base material and extruding the mixture and stretching the resultant if necessary, and the specific manufacturing process after the manufacturing of the film layer are the same as those in the first manufacturing example.

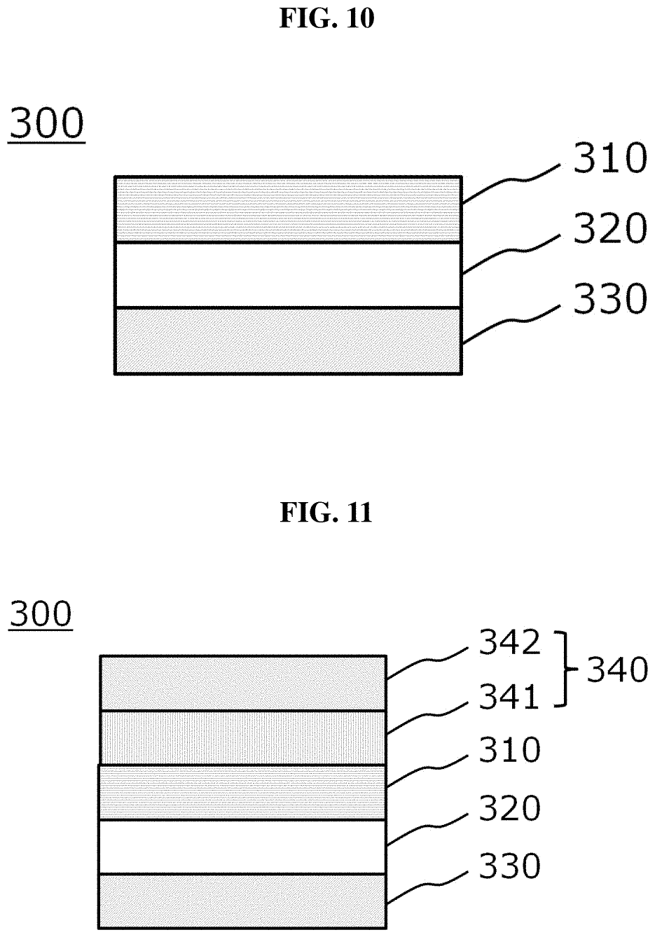

FIG. 10 is a schematic view illustrating a cross-section of anticorrosive coating paper according to a third embodiment of the present invention.

Referring to FIG. 10, the present invention discloses anticorrosive coating paper characterized in that in the anticorrosive coating paper 300 which is formed by laminating a base material 310 containing an anticorrosive agent and a first reinforcing material layer 330 with an adhesive layer 320 therebetween, the adhesive layer 320 has a mesh-like structure or a strip structure.

In the present invention, the base material 310 contains an anticorrosive agents through a method such as impregnation and coating and which is for preventing rusts and corrosion of a metal by forming a thin passive state film on the surface of the metal through the vaporization of the anticorrosive agent during packaging a final anticorrosive paper on a product such as a steel coil and by blocking contact with moisture and oxygen.

The type of the base material 310 is not particularly limited as long as a material, such as a natural material such as paper, a synthetic material such as nonwoven fabric and cloth, which is capable of achieving vaporizable anticorrosive performance, but a material including paper with excellent vaporizing performance is desirable, such as kraft paper, wiping paper, paperboard, tissue paper, or synthetic paper may preferably be used.

As described above, in the present invention, the anticorrosive agent is a composition which is contained in the base material 310 and forms a thin passive film on a metal surface of a product by being vaporized when packaging a product, and is not particularly limited as long as a composition including a vaporizable anticorrosive component.

However, the anticorrosive agent is required to have balanced volatility and sustained release and a composition suitable for impregnation and coating to a base material 310, in particular, to a paper base material. Thus, the present invention may include, as the anticorrosive agent, one or more selected from the group consisting of, for example, a fatty acid or a salt thereof, a cyclic compound including oxygen, nitrogen or sulfur, an alkali metallic salt, or an aromatic acid or a salt thereof.

The fatty acid may be selected from among fatty acids with carbon numbers of 3 to 20 and used, and more preferably, butyric acid, caproic acid, caprylic acid, capric acid, lauric acid, stearic acid, or the like may be selected and used.

In addition, for example, 1,2,3-benzotriazole, tolytriazole, 5-chlorobenzotriazole, mercaptobenzotriazole, 3-aminotriazole, imidazole or benzoimidazole may be selected and used as the cyclic compound.

In addition, for example, sodium carbonate, sodium benzoate, sodium nitrite, potassium nitrate, or potassium nitrite may be selected and used as the alkali metallic salt.

In addition, for example, salicylic acid or benzoic acid may be selected and used as the aromatic acid.

A suitable content ratio for the vaporizable anticorrosive agent may be composed of 5-30 wt % of the fatty acid or a salt thereof, 1-30 wt % of the cyclic compound, 1-20 wt % of the alkali metallic salt, 5-40 wt % of the aromatic acid or a salt thereof, and remaining contents of water or alcohol.

The base material 110 containing the anticorrosive agent may be manufactured by impregnating and coating a vaporizable anticorrosive agent to the base material through a method such as gravure, spray, or knife, and drying the gent with hot air or a heating roll. At this point, the applied amount of the vaporizable anticorrosive agent may be different according to the required degree of vaporization, but may be appropriately determined, for example, within a range of 5-100 g/m².

Here, an anticorrosive agent coating process using the gravure method is exemplarily described. First, the anticorrosive agent is applied to a gravure coating roll so that a desired amount of the anticorrosive agent is applied to the base material. While the base material passes between the gravure coating roll and a silicone roll, the anticorrosive agent is coated from one side surface and infiltrates into the other side surface. At this point, the distance between the gravure coating roll and the silicone roll is adjusted so that the anticorrosive agent easily infiltrates into the base material and the desired applied amount of anticorrosive agent is obtained. During the coating, in order to adjust a mechanical tension, work is performed by minimizing occurrence of tension before and after coating by controlling the mechanical operation speeds of an unwinder part and the rewinder part of an anticorrosive coating machine at a ratio of the speeds of the unrewinder part to the rewinder part at approximately 1.01-1.1:1 using a PIV continuously variable transmission. The unwinder part serves as a shaft for unwinding the roll that winds the base material, and the rewinder part serves as a shaft for rewinding the coated and dried base material. Subsequently, the base material which is coated with the vaporizable anticorrosive agent is dried in a drying chamber and the vaporizable anticorrosive agent is attached to the base material. The coated base material is dried while passing through the drying chamber, and the temperature of the drying chamber may be 60-120° C. Subsequently, if necessary, surface heat treatment is performed on the dried and coated base material using a heating roll, whereby redrying may be performed. The base material having passed through the drying chamber is brought into direct contact with the front and rear surfaces of the heating roll, which is set to about a temperature of 80-150° C., the anticorrosive agent infiltrating between fibrous pores of the base material is secondly dried, and the base material is pressed by bringing the surface of the base material into thermal contact with the heating roll, whereby the anticorrosive agent may be completely dried and a smooth coating base material may be manufactured.

In the present invention, the first reinforcing material layer 330 is a layer which is adhered to the base material 310 and which is for achieving improvement in the strength of the anticorrosive paper and moisture prevention performance and oil absorption prevention performance which are merits of existing anticorrosive film-type anticorrosive packaging material. The demerits of a conventional base material 310 composed of a paper material by preventing direct contact between the base material and a metal surface of a product by adopting a material having low moisture absorption and low oil absorption. In addition, the same level of anticorrosiveness as the existing anticorrosive paper by causing vaporizable anticorrosive components to smoothly move so that vaporizable anticorrosive performance may sufficiently be exhibited. Accordingly, the materials constituting the first reinforcing material layer 330 is not particularly limited as long as a material having low moisture absorption and low oil absorption aside from a paper material, but a material having excellent air permeability is applied so that the anticorrosive component vaporized from the anticorrosive paper is not blocked.

As a material for the first reinforcing material layer 330, for example, materials composed of gunnysacks, fabrics, or composites thereof may be adopted, and preferably, the gunnysacks may be adopted.

When a gunnysack fabric is used as a material for the first reinforcing material layer 330, the thread count (number of threads used per inch) is not particularly limited, for example, a gunnysack fabric with 10×10 thread count or 8×8 thread count may be used.

In the present invention, the adhesive layer 320 is a layer for adhering the base material to the first reinforcing material layer, has a mesh-like structure or a stripe structure, and thus, the anticorrosive components vaporized from most of the base material 310 containing the anticorrosive agent passes through the adhesive layer as it is and maintains excellent anticorrosive performance that is a merit of the conventional anticorrosive paper type.

The materials for the adhesive layer 320 is not particularly limited, but a commercial polyolefin resin based on polyethylene or polypropylene or a modified polyolefin resin thereof may preferably be used.

In the present invention, the adhesive layer 320 is formed by being laminated in a coating layer form between the base material 310 and the first reinforcing material layer 330, and the coating layer 320 is formed by 1) extruding a resin between the base material 310 and the first reinforcing material layer 330 through a T-die method and thermally adhering the resultant or 2) manufacturing a resin in a sheet shape by extrusion through a T-die method and laminating the sheet between the base material 310 and the first reinforcing material layer 330, whereby a coating layer 320 having a mesh-like structure may be formed by mixing the resin with an additive that forms a huge pore at the temperature of the extrusion.

The additive that forms a huge pore is mixed with the polyolefin resin and is gasified in an extrusion filming process during high-temperature extrusion under a condition of an extrusion temperature which is applied to a general polyolefin coating to a laminating process, for example, 170-370° C., preferably, 200-350° C., and formation of a huge two-dimensional pore, that is, ultra large through-hole that is visually identified, in the film is induced.

As such, additives which are mixed with a polyolefin-based resin and capable of forming an ultra large pore during extrusion as such, may include one or more inorganic material selected from the group consisting of, for example, calcium carbonate, talc, titanium dioxide, silica, barium sulfate, and mica, a foaming agent, a vaporizable anticorrosive agent, or a moisture-containing hydrophilic material, and preferably, a foaming agent or a vaporizable anticorrosive agent may be used when considering efficiency of forming a huge hole with which a bigger pore may be formed with a small content.

The foaming agent is not particularly limited, and a general foaming agent or an organic foaming agent or an inorganic foaming agent may be used.

The organic foaming agent may include, for example, acetone, ethyl acetate, halogen substituted alkane, hydrogen-containing fluoroalkane (HCFC), butane, pentane, isopentane, cyclopentane, hexane, isohexane, chlorofluoro alkane (trichloro monofluoro methane, dichloro fluoro methane, or the like), an azo compound (azobisisobutyronitrile, azodicarbon amide, or the like), a hydrazide compound (toluene sulfonyl hidrazide, 4,4′-oxybis(benzene sulfonyl hydrazide), arylbis(sulfohyl hydrazide), or the like), a semicarbazide-based compound (γ-toluylene sulfonyl semicarbazide and 4,4′-oxybis (benzene sulfonyl demicarbazide), or the like), an N-nitroso-based compound (N,N′-dinitroso pentamethyleme tetramine) or the like, and the inorganic foaming agent may include sodium hydrogen carbonate, sodium carbonate, ammonium hydrogen carbonate, ammonium carbonate, sodium nitrite, carbonium carbonate, ammonium acosate, sodium borohydride, azides, or the like.

The vaporizable anticorrosive agent is the same as the above-described anticorrosive agent used for the base material 310, and detailed descriptions thereon will be omitted.

The moisture-containing hydrophilic material is also a material which is mixed with a resin and vaporized at a high temperature during extrusion through a T-die method and capable of forming a huge pore, and for example, a hydrophilic material such as starch may be used by being made to contain moisture. However, extrusion equipment may receive strain due to moisture.

As such, in the third embodiment of the present invention, in forming the coating layer 320 by extruding a resin through a T-die method, an additive for forming a huge pore is mixed with the resin at the temperature of the extrusion, and thus, the coating layer with a mesh-like structure may be coated, and the mesh-like structure formed at this point has an indeterminate structure and has an ultra large ore structure in which the average size (with respect to the smallest inner diameter) of the pore is 1-300 mm, preferably 2-100 mm, and more favorably 5-50 mm, and the porosity per unit area is 10-90%, preferably 20-80%, and more preferably 30-70%, whereby when manufacturing a shape in which the first reinforcing material layer 330 is adhered to the base material 310, air permeability is not degraded due to the adjacent coating layer 320. At this point, the thickness of the formed coating layer 320 may be a thickness adopted for a general adhesive layer for the base material 310 and the first reinforcing material layer 330, for example, 1-500 μm, preferably 5-200 μm, and more preferably 10-100 μm.

The content of the additive that forms the ultra large pores in the coating layer expected in the present invention may be 1-30 wt %, preferably 2-20 wt %, and more preferably 3-15 wt % based on the total mixture with the resin added to achieve an ultra large pore structure having a suitable size and distribution. At this point, the additive may be used by being prepared in advance in a form of a master batch before mixed with the resin.

Meanwhile, as a method for such a mesh-like structure, a method not using the above-described additive may be considered.

That is, according to another implementation example of the third embodiment of the present invention, the adhesive layer 320 is formed by being laminated in form of the coating layer 320 between the base material 310 and the first reinforcing material layer 330, and the coating layer 320 is formed by 1) extruding a resin between the base material 310 and the first reinforcing material layer 330 through a T-die method and thermally adhering the resultant or 2) manufacturing a resin in a sheet shape by extrusion through a T-die method and a coating layer 320 having a mesh-like structure may be formed by laminating the sheet between the base material 310 and the first reinforcing material layer 330, wherein the extrusion temperature condition is set to 250-450° C.

According to the above-described implementation example, a coating layer 320 expected in the present invention may be achieved even without adding the additive by applying the condition of temperature of 250-450° C. which is a slightly higher than the extrusion temperature condition generally applied during extrusion of a resin through a T-die method, but in order to easily form an ultra large pore structure, it is desirable to use together the above-described inorganic material, such as calcium carbonate. Regarding other elements, the same description as those described in the above method of using an additive will be applied.

Meanwhile, in the present invention, an adhesive layer having a stripe structure may be achieved by closing a die slit at regular intervals during T-die type extrusion. At this point, the interval ratio of an adhesive forming section and a non-adhesive forming section may be 1:1.01-1:10, preferably 1:0.2-1:5, and more preferably 1:0.5-1:2.

FIG. 11 is a schematic view illustrating a cross-section of anticorrosive coating paper according to another implementation example of the third embodiment of the present invention.

Referring to FIG. 11, in anticorrosive coating paper 300 according to the present invention, a vaporization prevention layer 340 for preventing vaporization of an anticorrosive agent may further be laminated on a base material 310, that is, on a portion facing a first reinforcing material layer 330.

Such a vaporization prevention layer 340 may include: a film layer 341 including a polyolefin resin; or a second reinforcing material layer 342 which is a gunnysack, a nonwoven fabric, or a composite thereof. Preferably, the film layer 341 and the second reinforcing material layer 342 may be laminated on the base material 310.

The film layer 341 including a polyolefin resin is a layer generally used as a vaporization prevention layer in the anticorrosive paper manufacturing field, is used to impart a waterproof function while preventing vaporization of the components of the anticorrosive agent. For example, laminating using a polyolefin resin based on polyethylene or polypropylene or a modified polyolefin-based resin thereof may be applied.

The second reinforcing material layer 342 is a layer for reinforcing the strength and physical properties of the film layer 341, and materials such as films, gunnysacks, nonwoven fabrics, cloths, or a composite thereof which are commonly used in the technical field to which the present invention belongs may be used, and preferably, a gunnysack may be adopted. Here, when the gunnysack is used as a material for the second reinforcing material layer 342, the same description of the gunnysack of the first reinforcing material layer described above will be applied.

The lamination of the film layer 341 and the second reinforcing material layer 342 may be performed by extruding the film layer 341 in a T-die method between the base material 310 and the second reinforcing material layer 342 with the film layer 341 serving as an adhesive layer and thermally adhering the resultants.

The base material 310 containing an anticorrosive agent and an anticorrosive packaging material using the reinforcing material layers 330 and 342 should satisfy several requirements for packaging steel products such as steel coils. First is anticorrosiveness such that oxidization of metal due to transportation and storage after packaging a steel product may be prevented to protect the metal product. Second is strength, and in order to package a heavy steel coil, a certain tensile strength, tearing strength and a fracture strength are required. Third is a packaging suitability because when packaging a steel coil, the steel coil is packaged by an automatic or semi-automatic packaging machine or manually packaged in many cases, and in this case, the packaging work is easy only when the packaging material has bendability and flexibility, and there is no curl phenomenon as an additional important requirement. When a curl phenomenon occurs, the efficiency of the packaging work is degraded and tiredness increases.

The anticorrosive coating paper 300 according to the third embodiment of the present invention may exclude all demerits of anticorrosive packaging materials having anticorrosive paper forms and anticorrosive film forms while sufficiently satisfying the above requirements.

Regarding a coating method in which a resin coating layer is formed in one surface a base material, the present invention discloses a coating method as a fourth embodiment characterized in that a coating layer having a mesh-like structure is formed by 1) extruding a resin on one surface of the base material through a T-die method and thermally adhering the resultants or 2) manufacturing a resin in a sheet shape by extruding the resin through a T-die method and laminating the sheet, wherein an additive that forms a huge pore in the resin at the temperature of the extrusion to form the coating layer.

In the coating method according to the fourth embodiment of the present invention, an existing coating method is basically applied, that is, a method is applied in which 1) a coating layer is formed by extruding and thermally adhering the resin to one surface of the base material through a T-die method, or 2) firstly manufacturing a resin in a sheet shape by extruding the resin through a T-die method and laminating the base material and the manufactured sheet to form a coating layer.

In the present invention, the base material is a material capable of forming the coating layer, and is not particularly limited as long as a material, such as a natural material or a synthetic material which is capable of forming a coating layer on the base material by extruding a resin in a T-die method, or which is capable of being laminated with a coating layer prepared as a separate sheet shape.

Such a natural material or a synthetic material may include, for example, a paper material, a nonwoven fabric material, a fibrous material, a fabric material, or an air permeable plastic film, and the paper material may be one or more selected from the group consisting of kraft paper, wiping paper, paperboard, tissue paper, and synthetic paper.

In the present invention, the types of the resin used to form the coating layer is not particularly limited, for example, a polyolefin-based resin such as a polyethylene resin or a polypropylene resin which is used to impart adhesiveness may be used.

In the present invention, when a resin is extruded through a T-die method in order to achieve a mesh-like structure when forming a coating layer, an additive that forms a huge pore at the temperature of the extrusion is mixed and used with the resin.

The additive that forms a huge pore is mixed with the polyolefin resin and contributes to forming of a huge pore in an extrusion filming process during high-temperature extrusion in a condition of, for example, 170-370° C., preferably 200-350° C., or is sublimated or gasified, and induces formation of a huge two-dimensional pore, that is, an ultra large through-hole that is visually identified, in the film.

As such, additives which are mixed with a polyolefin-based resin and capable of forming an ultra large pore during extrusion as such, may include one or more inorganic material selected from the group consisting of, for example, calcium carbonate, talc, titanium dioxide, silica, barium sulfate, and mica, a foaming agent, a vaporizable anticorrosive agent, or a moisture-containing hydrophilic material, and preferably, a foaming agent or a vaporizable anticorrosive agent may be used when considering efficiency of forming a huge hole with which a bigger pore may be formed with a small content.

The foaming agent is not particularly limited, and a general foaming agent or an inorganic foaming agent may be used.

The organic foaming agent may include, for example, acetone, ethyl acetate, halogen substituted alkane, hydrogen-containing fluoroalkane (HCFC), butane, pentane, isopentane, cyclopentane, hexane, isohexane, chlorofluoro alkane (trichloro monofluoro methane, dichloro monofluoro methane, or the like), an azo compound (azobisisobutyronitrile, azodicarbon amide, or the like), a hydrazide compound (toluene sulfonyl hidrazide, 4,4′-oxybis(benzene sulfonyl hydrazide), arylbis(sulfohyl hydrazide), or the like), a semicarbazide-based compound (γ-toluylene sulfonyl semicarbazide and 4,4′-oxybis (benzene sulfonyl demicarbazide), or the like), an N-nitroso-based compound (N,N′-dinitroso pentamethyleme tetramine) or the like, and the inorganic foaming agent may include sodium hydrogen carbonate, sodium carbonate, ammonium hydrogen carbonate, ammonium carbonate, sodium nitrite, carbonium carbonate, ammonium acosate, sodium borohydride, azides, or the like.

The embodiment of the present invention is not particularly limited to the vaporizable anticorrosive agent, and a general vaporizable anticorrosive agent may be used.

The vaporizable anticorrosive agents may include, for example, one or more selected from the group consisting of a fatty acid or a salt thereof, a cyclic compound including nitrogen or sulfur, an alkali metallic salt, and an aromatic acid or a salt thereof.

The fatty acid may be selected from among fatty acids with carbon numbers of 3 to 20 and used, and more preferably, butyric acid, caproic acid, caprylic acid, capric acid, lauric acid, stearic acid, or the like may be selected and used.

In addition, for example, 1,2,3-benzotriazole, tolytriazole, 5-chlorobenzotriazole, mercaptobenzotriazole, 3-aminotriazole, imidazole, benzoimidazole, or the like may be selected and used as the cyclic compound.

In addition, for example, sodium carbonate, sodium benzoate, sodium nitrite, potassium nitrate, or potassium nitrite may be selected and used as the alkali metallic salt.

In addition, for example, salicylic acid or benzoic acid may be selected and used as the aromatic acid.

The moisture-containing hydrophilic material is also a material which is mixed with a resin and vaporized at a high temperature during extrusion through a T-die method and capable of forming a huge pore, and for example, a hydrophilic material such as starch may be used by being made to contain moisture. However, extrusion equipment may receive strain due to moisture.

As such, in the present invention, in forming a coating layer by extruding a resin through a T-die method, an additive for forming a huge pore is mixed with the resin at the temperature of the extrusion, and thus, the coating layer with a mesh-like structure may be coated, and the mesh-like structure formed at this point has an indeterminate structure and has an ultra large ore structure in which the average size (with respect to the smallest inner diameter) of the pore is 1-300 mm, preferably 3-100 mm, and more favorably 5-50 mm, and the porosity per unit area is 10-90%, preferably 20-80%, and more preferably 30-70%, whereby when manufacturing a shape of a composite sheet including various functional layer on the base material, the requirements for the material in which air permeability is not degraded due to the coating layer for adhering. The thickness of the coating layer formed at this point may be a thickness generally adopted when the coating layer is applied as an adhesive layer for the base material and another reinforcing layer, for example, 1-500 μm, favorably 5-200 μm, and more favorably 10-100 μm.

The content of the additive that forms the ultra large pore in the coating layer expected in the present invention may be 1-30 wt %, preferably 2-20 wt5, and more preferably 3-15 wt % based on the total mixture with the resin added to achieve an ultra large pore structure having a suitable size and distribution. At this point, the additive may be used by being prepared in advance in a form of a master batch before mixed with the resin.

Meanwhile, as a method for such a mesh-like structure, a method not using the above-described additive may be considered.

That is, regarding a coating method in which a resin coating layer is formed in one surface a base material, the present invention discloses a coating method, as another implementation of the fourth embodiment, characterized in that a coating layer having a mesh-like structure is formed by 1) extruding a resin on one surface of the base material through a T-die method and thermally adhering the resultants or 2) manufacturing a resin in a sheet shape by extruding the resin through a T-die method and laminating the sheet, wherein the coating layer having a mesh-like shape may be formed in a condition of the temperature of the extrusion is 250-450° C.

According to the above-described implementation example, a coating layer having a mesh-like structure expected in the present invention may be achieved even without adding the additive by applying the condition of temperature of 250-450° C. which is a slightly higher than the extrusion temperature condition generally applied during extrusion of a resin through a T-die method, but in order to easily form an ultra large pore structure, it is desirable to use together the above-described inorganic material, such as calcium carbonate. Regarding other elements, the same description as those described in the above method of using an additive will be applied.

Hereinafter, the present invention will be described in detail through examples.

### Example 1

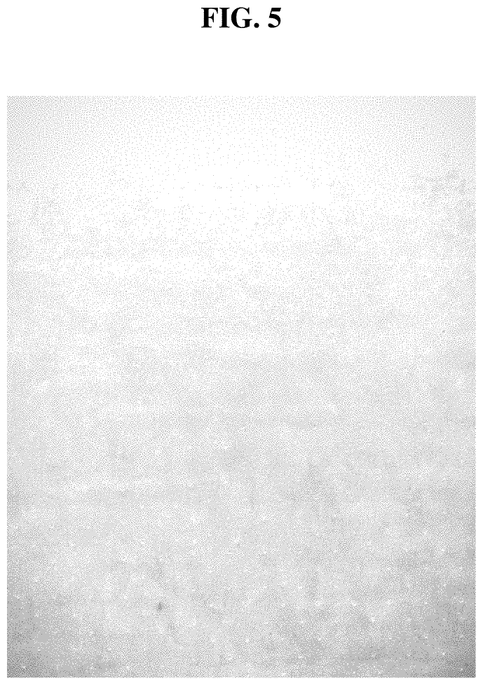

A vaporizable anticorrosive agent (20-25 wt % of caprylate, 5-10 wt % of 1,2,3-benzotriazole, 2-5 wt % of sodium nitrite, 20-25 wt % of benzoate, and 45-50 wt % of water) of 20 g/m² was impregnated in a kraft paper (80 g/m²) through a gravure method, the resultant was dried by hot air, and then a polyethylene film was laminated on one surface of the kraft paper. Subsequently, the kraft paper having a film layer formed thereon was punched several times using a pin roll, pores (diameter 400-800 μm and inter-pre distance 1.5-3.5 mm) were thereby formed, a biaxially oriented film (OPP film) and a polyethylene gunnysack (8×8 thread count) were coated (laminated in the order of OPP film and kraft paper) together on the other surface of the kraft paper with the polyethylene resin serving as an adhesive, whereby anticorrosive coating paper according to a first embodiment was manufactured. FIG. 5 illustrates the photograph of the surface of a film layer of the manufactured anticorrosive coating paper.

### Comparative Example 1-1

A vaporizable anticorrosive agent (20-25 wt % of caprylate, 5-10 wt % of 1,2,3-benzotriazole, 2-5 wt % of sodium nitrite, 20-25 wt % of benzoate, and 45-50 wt % of water) of 20 g/m² was impregnated in a kraft paper (80 g/m²) through a gravure method, the resultant was dried by hot air, and then a anticorrosive paper was manufactured by coating a biaxially oriented film (OPP film) through a T-die method with a polyethylene resin serving as an adhesive layer.

### Comparative Example 1-2

A vaporizable anticorrosive agent (20-25 wt % of caprylate, 5-10 wt % of 1,2,3-benzotriazole, 2-5 wt % of sodium nitrite, 20-25 wt % of benzoate, and 45-50 wt % of water) of 20 g/m² was impregnated in a kraft paper (80 g/m²) through a gravure method, the resultant was dried by hot air, and then a anticorrosive paper was manufactured by coating together a biaxially oriented film (OPP film) and a polyethylene gunnysack (8×8 thread count) through a T-die method with a polyethylene resin serving as an adhesive layer.

### Comparative Example 1-3

An anticorrosive master batch of 15 wt % and a polypropylene resin of 85 wt % were mixed and extruded through a T-die method and together coated a polypropylene gunnysack (9×9 thread count) through the T-die method, and the polypropylene resin was recoated on the opposite surface of the gunnysack through the T-die method.

### Experimental Example 1

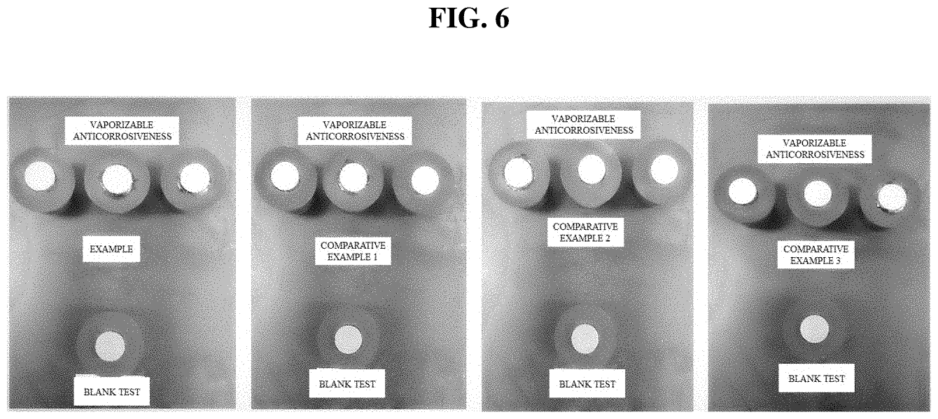

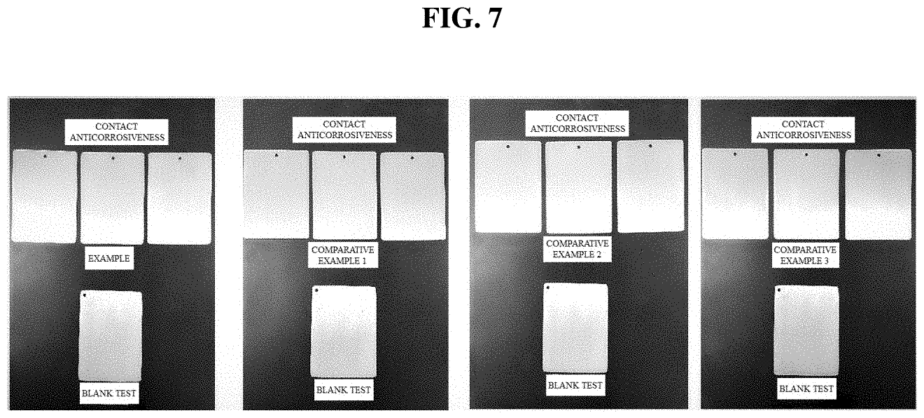

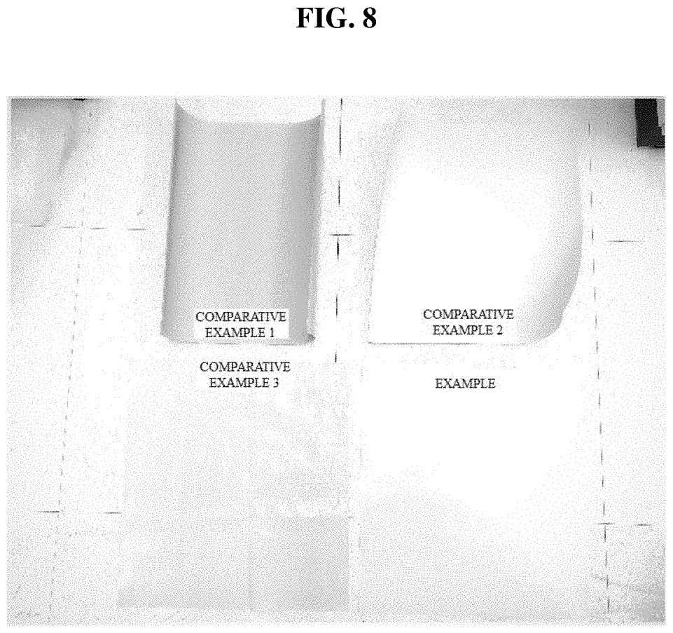

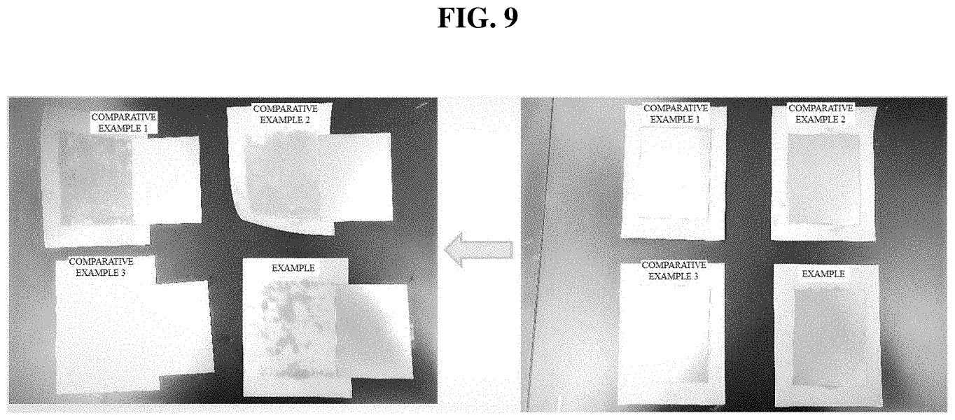

The physical properties of the manufactured anticorrosive paper and the anticorrosive film were measured and evaluated and the results thereof are illustrated in Table 1 and FIGS. 6 to 9.

[Method for Measuring and Evaluating Physical Properties]

(1) Vaporizable Anticorrosiveness and Contact Anticorrosiveness

Measurement was evaluated according to the KST 1086 standard.

(2) Moisture Permeability

Measurement was made according to the KST 1305 standard.

(3) Curling Property

The anticorrosive paper or the anticorrosive film were cut and developed in a size of about 0.5×0.5 m, and the degree of curl was relatively compared and evaluated after 1 hour elapses.

(4) Oil Absorption

The anticorrosive paper or the anticorrosive film were cut in a size of 110×150 mm, an 0.1 g of oil was applied on a 70×100 mm iron specimen, an oil applied surface of the iron specimen was then brought into contact with the anticorrosive paper or the anticorrosive film, and then the degree of absorption of the oil into the anticorrosive paper or the anticorrosive film was relatively compared and evaluated.

TABLE 1

| | | Comparative | Comparative | Comparative |
|---|---|---|---|---|
| | Example | example | example | example |
| Division | 1 | 1-1 | 1-2 | 1-3 |
| Vaporizable | Good | Good | Good | Rust |
| anticorrosiveness | | | | Occurs |
| Contact | Good | Good | Good | Rust |
| anticorrosiveness | | | | Occurs |
| Moisture | 4 | 9 | 5 | 3 |
| permeability | | | | |
| (g/m²/day) | | | | |
| Curling | Good | Curled | Curled | Good |
| property | | | | |
| Oil | Good | Bad | Bad | Good |
| absorption | | | | |

Referring to Table 1 and FIGS. 6 to 9, it may be confirmed that in the case of the anticorrosive coating paper to which the film layer having flow passages for providing vaporization passages for the anticorrosive agents on one surface of the base material, which contains the anticorrosive agents according to the first embodiment of the present invention, the curling phenomenon pointed out as demerits of the conventional anticorrosive papers is also remarkably mitigated while maintain excellent anticorrosive performance, moisture permeability, and oil absorption.

Comparatively, it may be understood that in the case of the existing anticorrosive papers (see comparative examples 1-1 and 1-2), to which a film layer like that in the present invention was not applied, there is no problem in anticorrosive performance, but the moisture permeability, curling property, and oil absorption which are pointed out as demerits of the conventional anticorrosive papers are not satisfactory, and in the case of an existing anticorrosive film (see comparative example 1-3), on the contrary, there is no problem in moisture permeability and oil absorption, but anticorrosiveness is remarkably degraded.

### Example 2-1

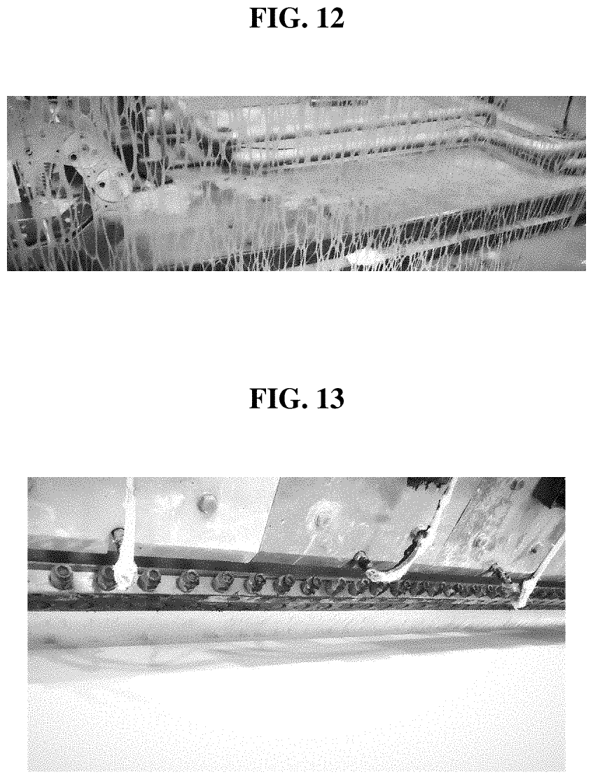

A vaporizable anticorrosive agent (20-25 wt % of caprylate, 5-10 wt % of 1,2,3-benzotriazole, 2-5 wt % of sodium nitrite, 20-25 wt % of benzoate, and 45-50 wt % of water) of 20 g/m² was impregnated in a kraft paper (70 g/m²) through a gravure method, the resultant was dried by hot air to prepare an anticorrosive agent-containing base material, a polyethylene gunnysack (8×8 thread count) was prepared as a first reinforcing layer, the resultant was extruded in a large width (3,000 mm) in a condition of an extrusion temperature of 200-350° C. through a T-die method with a polyethylene resin serving as an adhesive coating layer (thickness 30 μm), and thus the base material and the first reinforcing layer were thermally adhered. At this point, a vaporizable anticorrosive agent having the same composition as the above was mixed in a content of 5 wt % (polyethylene resin 95 wt %) of a master batch with the polyethylene resin, a first laminate was manufactured in which “an adhesive coating layer having the base material/mesh-like structure and the first reinforcing layer” were laminated in this order. It was confirmed that the mesh-like structure formed in the adhesive coating layer had an ultra large pore structure in which the average size (with respect to smallest inner diameter) of the pores was 5-50 mm, and the porosity per unit area was 50-60%, and the state of the adhesive coating layer that was extruded and formed from the T-die is illustrated in FIG. 12 and the state of the adhesive layer coated to the base material is illustrated in FIG. 13.

Subsequently, the first laminate and a same polyethylene gunnysack as the first reinforcing layer were prepared as a second reinforcing layer and were extruded in a large width (3,000 mm) in a condition of an extrusion temperature of 200-350° C. through a T-die method with a separate polyethylene resin serving as an adhesive film layer (thickness 20 μm), the first laminate and the second reinforcing layer were thermally adhered, and thus, a anticorrosive coating paper according to the third embodiment was finally manufactured which was composed of the “second reinforcing layer, the adhesive film layer, the base material, the adhesive coating layer having a mesh-like structure, and the first reinforcing material layer” in this order.

### Example 2-2

In order to compare and evaluate air permeability, only a first laminate was manufactured without adhering the second reinforcing layer in example 2-1 above.

### Comparative Example 2-1

A vaporizable anticorrosive agent (20-25 wt % of caprylate, 5-10 wt % of 1,2,3-benzotriazole, 2-5 wt % of sodium nitrite, 20-25 wt % of benzoate, and 45-50 wt % of water) of 20 g/m² was impregnated in a kraft paper (70 g/m²) through a gravure method, the resultant was dried by hot air, and then a anticorrosive paper was manufactured by coating a biaxially oriented film (OPP film) through a T-die method with a polyethylene resin serving as an adhesive layer.

### Comparative Example 2-2

A vaporizable anticorrosive agent (20-25 wt % of caprylate, 5-10 wt % of 1,2,3-benzotriazole, 2-5 wt % of sodium nitrite, 20-25 wt % of benzoate, and 45-50 wt % of water) of 20 g/m² was impregnated in a kraft paper (70 g/m²) through a gravure method, the resultant was dried by hot air, and then a anticorrosive paper was manufactured by coating together a biaxially oriented film (OPP film, thickness 20 μm) and a polyethylene gunnysack (8×8 thread count) through a T-die method with a polyethylene resin serving as an adhesive layer.

### Comparative Example 2-3

An anticorrosive master batch of 10 wt % and a polypropylene resin of 90 wt % were mixed and extruded (200-300° C.) through a T-die method and together coated a polypropylene gunnysack (10×10 thread count) through the T-die method, and the polypropylene resin was recoated (thickness 20 μm) on the opposite surface of the gunnysack through the T-die method.

### Comparative Example 2-4

In order to compare and evaluate air permeability, the adhesive coating layer in the example 2 was formed by only a polyethylene resin without adding a master batch, in which a vaporizable anticorrosive agent was processed, and thus, a first laminate was manufactured in the same manner as that in example 2 except that the adhesive coating layer is formed not in an “adhesive coating layer having a mesh-like structure, but in a “general adhesive coating layer”.

### Experimental Example 2-1

Regarding the anticorrosive paper and the anticorrosive film which are manufactured according to example 2-1, comparative examples 2-1 to 2-3, the physical properties thereof were measured through the following method and the results thereof were illustrated in Table 2.

[Method for Measuring and Evaluating Physical Properties]
Vaporizable anticorrosiveness and contact anticorrosiveness: evaluated according to KST 1086 standard.
Curling property: the anticorrosive paper or the anticorrosive film were cut and developed in a size of about 1×1 m, and the degree of curl was relatively compared and evaluated after 1 hour elapses.

TABLE 2

| | | Comparative | Comparative | Comparative |
|---|---|---|---|---|
| | Example | example | example | example |
| Division | 2-1 | 2-1 | 2-2 | 2-3 |
| Vaporizable | Good | Good | Good | Rust |
| anticorrosiveness | | | | Occurs |
| Contact | Good | Good | Good | Rust |
| anticorrosiveness | | | | Occurs |
| Curl | Good | Curl | Curl | Good |
| | | Occurs | Occurs | |

Referring to Table 2 above, it may be confirmed that the anticorrosive coating paper in which the base material containing an anticorrosive agent according to the third embodiment of the present invention and the first reinforcing material layer are laminated with an adhesive layer therebetween, is formed to have the adhesive layer having a mesh-like structure, and thus, a curling phenomenon that was pointed out as demerits of conventional anticorrosive papers is remarkably improved while maintaining excellent anticorrosive performance.

Comparatively, it may be understood that in the case of the existing anticorrosive papers (see comparative examples 1-1 and 2-2), to which a film layer like that in the present invention was not applied, there is no problem in anticorrosive performance, but the moisture permeability, curling property, and oil absorption which are pointed out as demerits of the conventional anticorrosive papers are also not satisfactory, and in the case of an existing anticorrosive film (see comparative example 2-3), on the contrary, there is no problem in moisture permeability and oil absorption, but anticorrosiveness is remarkably degraded.

### Experimental Example 2-2

The air permeability was measured for the first laminate manufactured according to example 2-2 and comparative example 2-4 and the results thereof was illustrated in Table 3 below.

[Air Permeability Measurement Method]

Measured according to KSM ISO 5631-1 standard.

TABLE 3

| | | Comparative |
|---|---|---|
| | Example | example |
| Division | 2-2 | 2-4 |
| Air | 7 min | 24 hour or more |
| permeability | | |
| (hour) | | |

Referring to Table 3 above, it may be confirmed that when the anticorrosive coating paper in which the base material containing an anticorrosive agent according to the third embodiment of the present invention and the first reinforcing material layer are laminated with an adhesive layer therebetween, is formed to have the adhesive layer having a mesh-like structure, air permeability performance is dramatically improved compared to that when the adhesive layer is configured not in the mesh-like structure but in a general adhesive layer.

### Example 3

A vaporizable anticorrosive agent (20-25 wt % of caprylate, 5-10 wt % of 1,2,3-benzotriazole, 2-5 wt % of sodium nitrite, 20-25 wt % of benzoate, and 45-50 wt % of water) of 20 g/m² was impregnated in a kraft paper (80 g/m²) through a gravure method, the resultant was dried by hot air, an anticorrosive agent-containing base material was prepared and a polyethylene gunnysack (8×8 thread count) was prepared, and thus, a polyethylene coating layer (thickness 30 μm) having a mesh-like structure was formed between the base material and the gunnysack. The polyethylene coating layer is thermally coated and formed on the anticorrosive kraft paper by extruding the polyethylene resin in a large width (3,000 mm) in a condition of an extrusion temperature of 200-350° C. through a T-die method, and gunnysack adhesive coating is performed by mixing a vaporizable anticorrosive agent having the same composition as the above with the polyethylene resin in a content of 5 wt % (polyethylene resin 95 wt %) of a processed master batch. It was confirmed that the mesh-like structure formed in the coating layer has an ultra large pore structure having an average size (with respect to smallest inner diameter) of 5-50 mm and porosity per unit area is 50-60%. The state of the coating layer extruded and formed from a T-die and the state of the coating layer coated on the base material are respectively illustrated in FIGS. 12 and 13.

In example 3 above, a process is illustrated in which the coating layer having a mesh-like structure and a gunnysack layer are formed on the base material, and various multilayer composite material may be manufactured by laminating another functional layer together with the base material aside from the gunnysack.

Heretofore, preferred embodiments of the present invention have been described in detail with reference to the accompanying drawings. The description of the present invention is illustrative and those skilled in the art could understand that modification into other specific forms could easily be made without changing the spirit and essential features of the present invention.

Thus, the scope of the present invention is represented not by the description of the present invention but by claims to be set forth later, and it should be understood that all the modified or changed forms derived from the meaning, scope, and equivalents thereto are included in the scope of the present invention.

1. Anticorrosive coating paper comprising:
a base material containing an anticorrosive agent;
a film layer adhered to one surface of the base material and having a flow passage that provides a vaporization passage for the anticorrosive agent; and
a reinforcing layer adhered to the other surface of the base material.

2. The anticorrosive coating paper of claim 1, wherein the base material is a natural material or a synthetic material.

3. The anticorrosive coating paper of claim 1, wherein the base material comprises paper.

4. The anticorrosive coating paper of claim 3, wherein the paper is one or more selected from the group consisting of kraft paper, wiping paper, paperboard, tissue paper, and synthetic paper.

5. The anticorrosive coating paper of claim 1, wherein the anticorrosive agent comprises one or more selected from the group consisting of a fatty acid or a salt thereof; a cyclic compound including nitrogen or sulfur; an alkali metallic salt; and an aromatic acid or a salt thereof.

6. The anticorrosive coating paper of claim 1, wherein the film layer comprises a polyolefin-based resin.

7. The anticorrosive coating paper of claim 1, wherein the flow passage is formed by punching.

8. The anticorrosive coating paper of claim 7, wherein the flow passage has a pore shape having a diameter of 1-2,000 μm and an inter-pore interval of 0.1-40 mm.

9. The anticorrosive coating paper of claim 1, wherein the flow passage is formed by a pore forming additive contained in a film base material.

10. The anticorrosive coating paper of claim 9, wherein the additive comprises at least one selected from the group consisting of calcium carbonate, talc, silica, or a foaming agent.

11. The anticorrosive coating paper of claim 1, wherein the film layer contains an anticorrosive component.

12. The anticorrosive coating paper of claim 1, wherein the reinforcing material layer is a film, a gunnysack, a nonwoven fabric, a cloth or a composite thereof.

13. A method for manufacturing anticorrosive coating paper, the method comprising:
(a) punching a film and providing a film layer having a flow passage that provides a vaporization passage for an anticorrosive agent;
(b) adhering the film layer having the flow passage to one surface of a base material containing the anticorrosive agent; and
(c) adhering a reinforcing material layer to the other surface of the base material.

14. A method for manufacturing anticorrosive coating paper, the method comprising:
(a) forming a film layer on one surface of a base material;
(b) punching the base material having the film layer formed thereon to form a flow passage that provides a vaporization passage for the anticorrosive agent, and
(c) adhering a reinforcing material layer to the other surface of the base material.

15. A method for manufacturing anticorrosive coating paper, the method comprising:
(a) adding and processing a pore forming additive to a film base material to form a film layer having a flow passage that provides a vaporization passage for an anticorrosive agent;
(b) adhering the film layer having the flow passage and one surface of a base material containing an anticorrosive agent to each other; and
(c) adhering a reinforcing material layer to the other surface of the base material.

16. Anticorrosive coating paper in which a base material containing an anticorrosive agent and a first reinforcing material layer are laminated and formed with an adhesive layer therebetween, wherein the adhesive layer comprises a mesh-like structure or a stripe structure.

17. The anticorrosive coating paper of claim 16, wherein the first reinforcing material layer is a gunnysack, a nonwoven fabric, a cloth or a composites thereof.

18. The anticorrosive coating paper of claim 16, wherein the adhesive layer comprises a polyolefin-based resin.

19. The anticorrosive coating paper of claim 18, wherein the mesh-like structure is a structure having an indeterminate shape and an ultra large pore structure in which an average size (with respect to smallest inner diameter) of pores is 1-300 mm, and a porosity per unit area is 10-90%.

20. The anticorrosive coating paper of claim 19, wherein the mesh-like structure is formed by adding an additive that forms a huge pore at the extrusion temperature when the adhesive layer is formed by extruding the resin through a T-die method.

21. The anticorrosive coating paper of claim 19, wherein the mesh-like structure is formed in a condition of the extrusion temperature of 250-450° C. when the adhesive layer is formed by extruding the resin through a T-die method.

22. The anticorrosive coating paper of claim 18, wherein in the stripe structure, an interval ratio of an adhesive layer forming section to a non-adhesive forming section is 1:0.1 to 1:10.

23. The anticorrosive coating paper of claim 16, wherein a vaporization prevention layer for preventing vaporization of the anticorrosive agent is further laminated on the base material.

24. The anticorrosive coating paper of claim 23, wherein the vaporization prevention layer comprises:
a film layer comprising a polyolefin-based resin; or
a second reinforcing material layer which is a gunnysack, a nonwoven fabric, a cloth, or a composite thereof.

25. A coating method for forming a resin coating layer on one surface of a base material, the coating layer being formed by 1) extruding a resin on one surface of the base material through a T-die method and thermally adhering the resultant or 2) manufacturing a resin in a sheet shape by extruding the resin through the T-die method and then laminating the base material and the sheet,
wherein an additive that forms a huge pore at a temperature of the extrusion is added to the resin to form the coating layer with a mesh-like structure.

26. The coating method of claim 25, wherein the resin comprises a polyolefin-based resin.

27. The coating method of claim 25, wherein the additive is one or more selected from the group consisting of: one or more inorganic materials selected from the group consisting of calcium carbonate, talc, titanium dioxide, silica, barium sulfate, and mica; a foaming agent; a vaporizable anticorrosive agent; and a hydrophilic material containing moisture.

28. A coating method for forming a resin coating layer on one surface a base material, the coating layer is formed by 1) extruding a resin on one surface of the base material through a T-die method and thermally adhering the resultant or 2) manufacturing a resin in a sheet shape by extruding the resin through the T-die method and laminating the base material and the sheet,
wherein the coating layer with a mesh-like structure is formed in a condition that a temperature of the extrusion is 250-450° C.
